(19) United States
(12) Patent Application Publication
(10) Pub. No.: US 2017/0181564 A1
(43) Pub. Date: Jun. 29, 2017

(54) Multifunctional Cooking Pot

(71) Applicants: Zhigang He, Foshan (CN); Hui Zheng, Foshan (CN)

(72) Inventors: Zhigang He, Foshan (CN); Hui Zheng, Foshan (CN)

(73) Assignees: Zhigang He, Foshan (CN); Hui Zheng, Foshan (CN)

(21) Appl. No.: 15/223,593

(22) Filed: Jul. 29, 2016

(30) Foreign Application Priority Data
Dec. 25, 2015 (CN) 201521113665.X

(51) Int. Cl. A47J 27/00

(52) U.S. Cl. CPC A47J 27/002; A47J 27/004

(57) ABSTRACT

A cooking pot comprises a pot body, a control device, an electrical heating device, a thermostat and a temperature sensor, wherein the electrical heating device, thermostat and temperature sensor are provided in the pot body, and the control device is connected with the electrical heating device, thermostat and temperature sensor, characterized in that the said pot body is provided with an outer pot and an inner pot, the electrical heating device clings to or is close to the outer pot, the inner pot is provided inside the outer pot, and the external bottom surface of the inner port is in contact with the internal bottom surface of the outer pot.

This application claims priority to Chinese Patent Application Ser. No. 60 CN201521113665.X filed 25 Dec. 2015.

### TECHNICAL FIELD

This utility model relates to the filed of electrically heated pot technology, particularly to a cooking pot.

### BACKGROUND ART

Currently, there are a wide variety of electrically heated pots for food cooking or heating available in the market, which are generally composed of the inner pot and the outer pot; the inner pot is placed in the outer pot and its bottom is in direct contact with the heat source for heating. For example, in the invention entitled “Full steam-heated cooking pot” (Chinese Patent Application No. CN88104268.4), the pot is composed of the inner pot and the outer pot, the inner pot is neither in direct contact with the heater, nor in contact with the outer pot, and the inner pot is completely and evenly heated by the steam between the inner pot and the outer pot; the food can be fully cooked and its original flavor can be maintained regardless of boiling, stewing and other cooking methods. Its main characteristic is that it is provided with a pressure vent valve and safety valve in combination with a constant pressure valve or in combination with a pressure control value which can regulate the pressure depending on the food, and steam heat is used to achieve even and complete heating; it is safe and can save cooking time; in addition, it can maintain the original food flavor. Its shortcoming is that it only has few functions and can only be used for food steaming and boiling rather than frying, baking, etc.

### SUMMARY OF THE INVENTION

The objective of this utility model is to provide a multifunctional cooking pot featured by simple structure, easy use, high thermal efficiency, safety and energy saving, so as to solve the shortcomings of the prior art.

This utility model adopts the following technical solution to achieve the above objective: A multifunctional cooking pot, comprising a pot body, control device, electrical heating device, thermostat and temperature sensor, wherein the electrical heating device, thermostat and temperature sensor are provided in the pot body, and the control device is connected with the electrical heating device, thermostat and temperature sensor, characterized in that the said pot body is provided with an outer pot and an inner pot, the electrical heating device clings to or is close to the outer pot, the inner pot is provided inside the outer pot, the external bottom surface of the inner port is in contact with the internal bottom surface of the outer pot, after heating by the electrical heating device, the heat is transferred into the inner pot through the bottom surface of contact between the outer pot and the inner pot as well as the peripheral air or water between the outer pot and the inner pot, so as to cook the food in the inner pot.

As a further explanation of the above solution, the said outer pot is fixed inside the pot body, the electrical heating device comprises a heating tube and a heating strip, the bottom of the outer pot is grooved, and the heating tube is pressed into the bottom groove; the side periphery of the outer pot is provided with the heating strip, and the heating tube and heating strip are independently controlled by the control device, so as to provide electrical heating according to different cooking functions.

The bottom of the said outer pot and the peripheral portion of the outer pot near the electrical heating device are provided with a temperature sensor, which collects and transmits temperature data to the microcomputer program of the control device.

The said thermostat is provided at the bottom of the outer pot, which protects the product from danger due to overheating in a non-normal state.

The said inner pot is detachable from the said outer pot; at the time of cooking, the user puts food in the interior space of the inner pot directly, and puts nothing or an appropriate amount of water in the interior space of the outer pot.

The said pot body is provided with a mounting position for the installation of the control device, the control device includes a control circuit board and panel buttons, and a heat shield of panel is provided on the backside of the control circuit board.

The bottom of the said outer pot is provided with a support stand, and the support stand is fixed onto the bottom of the pot body, so that a cooling chamber is formed between the bottom of the outer pot and the pot body.

The top of the said pot body is provided with a pot lid, the pot lid is provided with a lid handle, both sides of the upper edge of the inner pot are provided with an inner pot handle, and both sides of the pot body are provided with a pot body handle.

The beneficial effects which can be achieved by this utility model through the adoption of the said technical solution:

1. The utility model adopts the structure of combination of the inner pot and the outer pot, the outer pot is fixed inside the pot body, the external bottom surface of the inner port is in contact with the internal bottom surface of the outer pot, after heating by the heater installed on the outer pot, the heat is transferred into the inner pot through the bottom surface of contact between the outer pot and the inner pot as well as the peripheral air or water between the outer pot and the inner pot, so as to achieve steaming, boiling and other functions and cook the food in the inner pot evenly; in addition, as the inner pot can be freely taken out, the inner space of the outer pot can also be directly used for food cooking, so as to achieve frying, baking and other functions.

2. The bottom of the said outer pot of the utility model and the peripheral portion of the outer pot near the heater are provided with a temperature sensor, which collects and transmits temperature data to the microcomputer program of the control panel; on the one hand, it can cook food according to the program preset by the control device, on the other hand, the thermostat of the outer pot can protect the product from danger due to overheating in a non-normal state.

### DESCRIPTION OF THE DRAWINGS

FIG. 1 is a schematic view of the structure of the utility model;

FIG. 2 is a partial cross-sectional view of the novel utility.

Explanation of symbols in the drawings: 1. Pot body 2. Control device 2-1. Control circuit board 2-2. Panel buttons 2-3. Heat shield of panel 3. Electrical heating device 3-1. Heating tube 3-2. Heating strip 4. Thermostat 5. Pot lid 6. Pot lid handle 7. Inner pot handle. 8. Pot body handle 9. Base plate 10. Power supply mounting plate seat 11. Power supply circuit board 12. Outer pot 13. Inner pot.

### DETAILED DESCRIPTION OF THE PREFERRED EMBODIMENTS

The technical solution is described in detail below with reference to the specific embodiments.

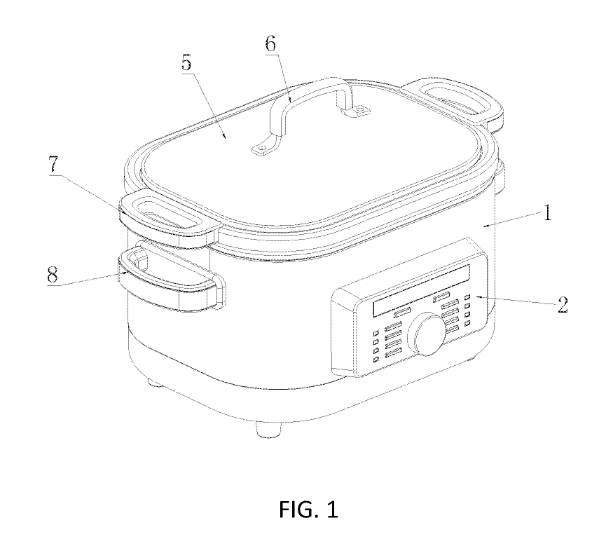

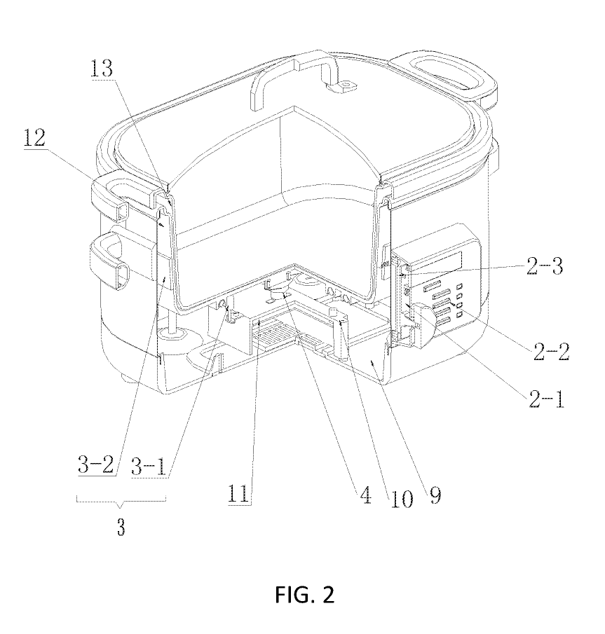

As shown in FIGS. 1 and 2, this utility model is a multifunctional cooking pot, comprising a pot body 1, control device 2, electrical heating device 3, thermostat 4 and temperature sensor, wherein the electrical heating device, thermostat and temperature sensor are provided in the pot body, and the control device is connected with the electrical heating device, thermostat and temperature sensor. The top of the pot body 1 is provided with a pot lid 5, the pot lid is provided with a lid handle 6, both sides of the upper edge of the inner pot are provided with an inner pot handle 7, both sides of the pot body are provided with a pot body handle 8, the bottom of the pot body is provided with a base plate 9, the base plate is provided with a power supply mounting plate seat 10, the power supply mounting plate seat is provided with a power supply circuit board 11, and the power supply circuit board is connected with the control device. The pot body is provided with an outer pot 12 and an inner pot 13, the electrical heating device clings to or is close to the outer pot, the inner pot is provided inside the outer pot, the external bottom surface of the inner port is in contact with the internal bottom surface of the outer pot, after heating by the electrical heating device, the heat is transferred into the inner pot through the bottom surface of contact between the outer pot and the inner pot as well as the peripheral air or water between the outer pot and the inner pot, so as to cook the food in the inner pot.

In this embodiment, the outer pot 12 is fixed inside the pot body 1, the electrical heating device 3 comprises a heating tube 3-1 and a heating strip 3-2, the bottom of the outer pot is grooved, and the heating tube is pressed into the bottom groove; the side periphery of the outer pot is provided with the heating strip, and the heating tube and heating strip are independently controlled by the control device, so as to provide electrical heating according to different cooking functions.

The bottom of the said outer pot and the peripheral portion of the outer pot near the electrical heating device are provided with a temperature sensor, which collects and transmits temperature data to the microcomputer program of the control device. The thermostat is provided at the bottom of the outer pot, which works with the fuse connected with the control device and protects the product from danger due to overheating in a non-normal state.

The said inner pot is detachable from the said outer pot; at the time of cooking, the user puts food in the interior space of the inner pot directly, and puts nothing or an appropriate amount of water in the interior space of the outer pot. The pot body is provided with a mounting position for the installation of the control device 2, the control device includes a control circuit board 2-1 and panel buttons 2-2, and a heat shield of panel 2-3 is provided on the backside of the control circuit board. The bottom of the said outer pot is provided with a support stand, and the support stand is fixed onto the bottom of the pot body, so that a cooling chamber is formed between the bottom of the outer pot and the pot body.

As described in this technical solution, the outer pot is fixed inside the pot body, the inner pot is put inside the outer pot completely, the external bottom surface of the inner port is in contact with the internal bottom surface of the outer pot, after heating by the heater installed on the outer pot, the heat is transferred into the inner pot through the bottom surface of contact between the outer pot and the inner pot as well as the peripheral air or water between the outer pot and the inner pot, so as to achieve steaming, boiling and other functions and cook the food in the inner pot evenly; in addition, as the inner pot can be freely taken out, the inner space of the outer pot can also be directly used for food cooking, so as to achieve frying, baking and other functions; the bottom of the outer pot and the peripheral portion of the outer pot near the heater are provided with a temperature sensor, which collects and transmits temperature data to the microcomputer program of the control panel; on the one hand, it can cook food according to the program preset by the control device, on the other hand, the thermostat of the outer pot can protect the product from danger due to overheating in a non-normal state.

The above description is only the preferred embodiments of this utility model, it should be noted that without departing from the creative concept of this utility model, those of ordinary skill in the art can also make a number of modifications and improvements, which shall also fall within the scope of protection of this utility model.

What is claimed is:

1. A multifunctional cooking pot, comprising a pot body, a control device, an electrical heating device, a thermostat and a temperature sensor, wherein the electrical heating device, the thermostat and the temperature sensor are provided in the pot body, and the control device is connected with the electrical heating device, the thermostat and the temperature sensor, characterized in that the pot body is provided with an outer pot and an inner pot, the electrical heating device clings to or is close to the outer pot, the inner pot is provided inside the outer pot, and the external bottom surface of the inner port is in contact with the internal bottom surface of the outer pot.

2. The multifunctional cooking pot according to claim 1, characterized in that said outer pot is fixed inside the pot body, and the electrical heating device comprises a heating tube and/or a heating strip.

3. The multifunctional cooking pot according to claim 2, characterized in that the bottom of said outer pot is grooved, and the heating tube is pressed into the bottom groove.

4. The multifunctional cooking pot according to claim 2, characterized in that said heating strip is provided on the side periphery of the outer pot.

5. The multifunctional cooking pot according to claim 1, characterized in that the bottom of said outer pot and the peripheral portion of the outer pot near the electrical heating device are provided with a temperature sensor, which collects and transmits temperature data to the microcomputer program of the control device.

6. The multifunctional cooking pot according to claim 1, characterized in that said thermostat is provided at the bottom of the outer pot.

7. The multifunctional cooking pot according to claim 2, characterized in that said inner pot is detachable from said outer pot.

8. The multifunctional cooking pot according to claim 1, characterized in that said pot body is provided with a mounting position for the installation of the control device, the control device includes a control circuit board and panel buttons, and a heat shield of panel is provided on the backside of the control circuit board.

9. The multifunctional cooking pot according to claim 1, characterized in that the bottom of said outer pot is provided with a support stand, and the support stand is fixed onto the bottom of the pot body, so that a cooling chamber is formed between the bottom of the outer pot and the pot body.

10. The multifunctional cooking pot according to claim 1, characterized in that the top of said pot body is provided with a pot lid, the pot lid is provided with a lid handle, both sides of the upper edge of the inner pot are provided with an inner pot handle, and both sides of the pot body are provided with a pot body handle.
